(19) United States
(12) Patent Application Publication
(10) Pub. No.: US 2022/0371401 A1
(43) Pub. Date: Nov. 24, 2022

(54) AUTOMATIC AIR OUTLET SYSTEM HAVING VARIOUS VENTILATION SITUATIONS

(71) Applicant: ILLINOIS TOOL WORKS INC., Glenview, IL (US)

(72) Inventors: Ulrike ROTH, Sembach (DE); Thomas PACHER, Sembach (DE); Manfred GROBEN, Gau-Bickelheim (DE); Markus ENGLERT, Homburg (DE); Günther KRÄMER, Enkenbach-Alsenborn (DE)

(21) Appl. No.: 17/642,098

(22) PCT Filed: Sep. 9, 2020
(86) PCT No.: PCT/US2020/049802

§ 371 Date: Mar. 10, 2022

(30) Foreign Application Priority Data
Sep. 17, 2019 (DE) 10 2019 125 015.3

(51) Int. Cl. B60H 1/00

(52) U.S. Cl. CPC B60H 1/00842; B60H 1/00742; B60H 1/00735

(57) ABSTRACT

An automatic air outlet system for supplying air into a vehicle interior of a vehicle, wherein the automatic air outlet system includes a plurality of air outlets that are motorized and may be automatically adjusted and that respectively include a plurality of setting parameters, a storage unit for storing a plurality of ventilation situations, wherein in the case of each of the plurality of ventilation situations a specific configuration of the setting parameters of each air outlet of the plurality of air outlets is specified, the configuration being adjusted to the corresponding ventilation situation, a specification unit for the purpose of specifying a ventilation situation to the plurality of ventilation situations that are stored in the storage unit, and a control unit for the purpose of controlling the plurality of air outlets such that the air outlets fulfil the ventilation situation that is specified by the specification unit.

### TECHNICAL FIELD

The present invention relates to an automatic air ventilation system for feeding air into a passenger compartment of a vehicle.

### BACKGROUND

In ventilation devices for vehicles, generally air outlets are used which permit selective control of the emerging or outflowing jet of air. Such air outlets serve to supply in particular fresh air into the passenger compartment of a vehicle.

The airflow flows here via an inlet opening in the corresponding air outlet into an air duct that is at least partially bounded by the housing wall of the air outlet, said air flow passing through said air duct and finally through the outlet opening of the air outlet and into the passenger compartment of the vehicle (for example passenger car or truck). As a rule, the strength of the flow, that is to say the quantity of air flowing into the passenger compartment of the vehicle via the air outlet per unit of time, can be adjusted manually using an actuator element.

Furthermore, air outlets are as a rule also provided with airflow-orienting or airflow-regulating air-guiding or directing elements which can be manipulated correspondingly, in order to bring about targeted deflection or orientation of the airflow that is output by the air outlet. This orientation can be, for example, in a vertical and/or horizontal direction, and can also be adjusted manually by means of actuator elements.

Furthermore as a rule air outlets have closure devices in order to be able to change them from an open state, in which air can flow out of the air outlet, into a closed state, in which air cannot flow out of the air outlet, and vice versa.

In addition, as a rule the temperature of individual air outlets or a plurality of air outlets can also be set jointly, in order to introduce cold or heated air into the passenger compartment of the vehicle.

In summary, in air outlets an open/closed state, a flow temperature, an intensity of flow and a flow direction can therefore usually be set by means of actuator elements. In this context, the actuator element can typically be manually adjusted individually and then remain in their set position.

Furthermore, there are already developments to the effect that individual actuator elements of the air outlets can be actuated not only manually but additionally to this or alternatively to this by motor. For this purpose, it is known to assign to the actuator element a motor-operated, in particular electromotive, drive for manipulating individual actuator elements, which drive is coupled mechanically to the corresponding actuator element of the air outlet in such a way that by actuating the motor-operated drive it is possible to manipulate the actuator element that is assigned to the drive.

However, in this context it continues to be possible as before for the driver or an occupant of the vehicle to operate and set individual actuator elements.

With the known air outlets, and in air outlet systems that are composed of the known air outlets, there are problems insofar as they cannot be operated quickly and simply enough to avoid distracting the driver from the road or delaying his journey. Furthermore, there is a problem insofar as known air outlet systems are not tailored to the requirements of the driver or of the passengers or cannot be set by them in an optimum way (since they also require, for example, flow calculations or extensive knowledge of airflow behaviors).

### SUMMARY

An object of the present invention is therefore to specify an automatic air outlet system that is fast and simple to operate and provides a high level of comfort to vehicle occupants.

The solution according to the invention consists in specifying an automatic air outlet system for supplying air into a vehicle interior of a vehicle, wherein the automatic air outlet system comprises the following: a plurality of air outlets that are motorized and may be automatically adjusted and that respectively comprise a plurality of setting parameters; a storage unit for storing a plurality of ventilation situations, wherein in the case of each of the plurality of ventilation situations a specific configuration of the setting parameters of each air outlet of the plurality of air outlets is specified, said configuration being adjusted to the corresponding ventilation situation; a specification unit that is embodied for the purpose of specifying a ventilation situation to the plurality of ventilation situations that are stored in the storage unit; and a control unit that is embodied for the purpose of controlling the plurality of air outlets in such a manner that said air outlets fulfil the ventilation situation that is specified by the specification unit.

The object is satisfactorily achieved with the automatic air outflow system according to the invention. In particular, by means of the automatic air outflow system and the stored ventilation situations it is possible to carry out fast and simple operation of the air outlets, in a way that is adapted to various requirements of the vehicle occupants. These requirements are described as ventilation situations and are selected manually by means of the specification unit (also by voice control or remote control (by means of a smartphone, key, etc.)) or are preferably selected automatically. In the case of an automatic selection, interaction can occur with the sensor system of the vehicle.

An automatically adjustable, motorized air outlet is understood to be one which can be adjusted automatically by means of a motor, preferably an electric motor.

The corresponding motor or motors is/are then actuated by means of the control unit in such a way that they fulfil the ventilation situation that is specified by the specification unit.

A further advantage of the invention is that it is possible, for example by means of a smartphone or key or smart key, to carry out personalized air-conditioning of the vehicle. In conventional air outlet systems it has not been possible to specify individual desired air conditioning settings as ventilation situations. It is now possible here to store a personalized desired air conditioning setting in the storage unit so that the desired air conditioning setting does not have to be set anew when the vehicle is entered and can be implemented (automatically). The desired air conditioning setting can be connected, for example, to a seat memory function so that when the corresponding seat setting is selected by a vehicle occupant the associated air conditioning setting is automatically selected.

Consequently it is conceivable that at least some of the multiplicity of ventilation situations are desired situations whose configuration can be defined by drivers or vehicle occupants.

Although it has been stated here that the control unit is designed to actuate the multiplicity of air outlets in such a way that they fulfil the ventilation situation that is specified by the specification unit, in this context it is also conceivable that a plurality of ventilation situations can be implemented simultaneously, i.e. in parallel.

According to one advantageous development of the invention, the specification unit has at least one sensor, preferably a multiplicity of sensors, wherein the specification unit automatically specifies, based upon a measured variable of the sensor, at least some of the ventilation situations that are stored in the storage device.

If the specification unit has sensors, it can detect automatically a vehicle state by means of the sensors and then specify a suitable ventilation situation of the stored ventilation situations based upon the measured variable.

Therefore, the need for manual specification of at least some of the ventilation situations stored in the storage unit is dispensed with, so that the comfort of the vehicle occupants can be increased further.

According to one advantageous development of the invention, the at least one sensor is an optical sensor, a weight sensor, a temperature sensor, an infrared sensor, a moisture sensor or a contact sensor.

In this context, the optical sensor can detect, for example, a state of fatigue of the driver, and the weight sensor can detect, for example, the presence of a vehicle occupant on a seat. The temperature sensor can detect, for example, the temperature of a vehicle part (for example steering wheel) or the temperature of the interior of the vehicle, and the infrared sensor can detect, for example, the thermal radiation of the body of a vehicle occupant. Furthermore, the moisture sensor can, for example, detect whether a driver has moist hands, and the contact sensor can detect, for example, whether a vehicle door has been immediately opened.

The sensors can therefore supply information about the state of the vehicle and thus specify a ventilation situation which matches the state.

According to one advantageous development of the invention, the specification unit receives a touchscreen input, an operating element input, a voice input and/or an input by means of a smartphone or key for specifying at least some, preferably all, the ventilation situations that are stored in the storage unit.

In this context, it is conceivable that all of the ventilation situations can be specified directly by the driver or vehicle occupant in addition to the specification by means of a sensor. Correspondingly, the driver or vehicle occupant is provided with the possibility of selecting a ventilation situation directly from the ventilation situations that are stored in the storage unit.

In this context, the control can be embodied in such a way that the specification of a ventilation situation by the driver or the vehicle occupant is dominant over the specification of the ventilation system by the sensor. As a result, the driver does not have the feeling that the ventilation system of the vehicle is not complying with his wishes.

According to one advantageous development of the invention, the setting parameters of the multiplicity of air outlets have at least two, preferably all, of the following parameters: opened/closed state; flow temperature; flow strength; flow direction.

In the opened state of the air outlet, air can flow from the air outlet into the vehicle, and in the closed state air cannot flow from the air outlet into the vehicle. The opened state of the air outlet is often also understood as such an optimum opened state which assists the desired function or situation (e.g. heating situation). This state therefore does not have to be the completely opened state of the air outlet. The flow temperature specifies the temperature of the air flowing out of the air outlet and lies, for example, in a low, medium or high range. A low range lies here, for example, between 15° C. and 20° C., a medium range lies, for example, between 20° C. and 25° C., and a high range lies, for example, between 25° C. and 30° C. The flow strength is the quantity of air flowing into the interior of the vehicle via the air outlet per unit of time, and the flow direction is the direction in which the air flows out of the air outlet.

According to an advantageous development of the invention, at least two, preferably at least three of the following ventilation situations are included in the plurality of the ventilation situations that are stored in the storage unit: a warming up situation having optimized setting parameters for rapidly warming up the vehicle interior prior to starting a journey; a cooling down situation having optimized setting parameters for rapidly cooling down the vehicle interior prior to starting a journey; a ventilating situation having optimized setting parameters for rapidly exchanging the air in the vehicle interior; a solo-traveling situation having optimized setting parameters for solo-traveling; a rear seat situation having optimized setting parameters when passengers are on the rear seat; a telephoning situation having optimized setting parameters when telephoning on a hands-free device; a situation for maintaining alertness having optimized setting parameters for maintaining the alertness of a driver and/or waking up a driver; a hand warming up/cooling down situation for warming up and/or cooling down the hands of a driver; a personalization situation having personalized, preset parameters of occupants; and a fan situation having optimized setting parameters for oscillating air in the vehicle interior.

In the personalization situation, the setting parameters are set to personalized, preset or preferred parameters of the vehicle occupants. These parameters can be activated, for example, by a memory function (preferably using a smartphone or key). Therefore, a personalized air conditioning setting of the vehicle is possible. In this context, the personalization situation can also be stored with its personalized parameters in the storage unit, so that it is conceivable that at least some of the plurality of ventilation situations are personalization situations whose configuration can be defined by drivers or vehicle occupants.

The personalization situation can be connected here to the seat memory function in such a way that when the corresponding seat setting is selected by a vehicle occupant, the associated air conditioning setting which has the parameters which are personalized by the vehicle occupant is automatically selected. With the selection of “his” seat setting, the vehicle occupant can also directly select “his” air conditioning setting.

It would also be conceivable here that the respective vehicle occupant only carries out personalization of his air conditioning zone, that is to say the one surrounding him, so that a plurality of personalization situations can be implemented one next to the other.

According to one advantageous development of the invention, in the warming up situation, each of the plurality of air outlets is in the opened state, the flow temperature is high, the flow strength is high and the flow direction of the plurality of air outlets is oriented toward seats, toward windows, toward the roof and/or toward the steering wheel and/or further operating elements of the vehicle.

The warming-up situation is typically a scenario with frosty weather. It may therefore be a case here, for example, of a frosty morning in which the external temperatures are below 0° C., which occurs in Germany on at least 50 days per year.

The problem with conventional air outlet systems is that the stationary-state heating does not interact efficiently with these systems. For example, until now when the stationary-state heat has been operating the warm air has been directed in the direction of the last flow direction or lamellar position of the air outlet. The warmed airflow therefore impinges on random points in the vehicle and not on those which particularly require warming up. Furthermore it is possible that individual air outlets are in their closed state so that no heated air at all can flow into the interior of the vehicle through them. Overall, the warming up of the vehicle interior therefore does not take place efficiently.

In the “warming up” ventilation situation, each of the plurality of air outlets is in the opened state so that an exchange of air is possible within a relatively short time and savings in energy can be achieved by means of a shorter running time of the stationary-state heater. Furthermore, the flow temperature and the flow strength are specified to be high so that this exchange can be achieved as quickly as possible and the vehicle occupants are presented with a vehicle interior at a comfortable temperature. Therefore, the flow direction, open state, temperature control and flow strength are optimized in terms of fluidics, in order to ensure “optimum” heating.

In addition, at least some, preferably all, of the air outlets of the plurality of air outlets are oriented toward seats, toward windows, and/or toward the steering wheel of the vehicle, in order to heat these elements as quickly as possible to the required temperature. For example, through airstreams oriented toward windows it is possible to bring about relatively fast defrosting of the window so that energy savings through shorter running times of the stationary-state heater are also possible here. If further air outlets are oriented toward the steering wheel or the seats, the comfort of the driver increases, being presented with a preheated steering wheel and/or a preheated seat.

In the “warming up situation” ventilation situation it would, for example, be possible to use a contact sensor and a temperature sensor, when the vehicle is closed or opened, automatically specify the “warming up situation” ventilation program if the external temperature is below a specific value (for example 0° C., 5° C. or already 10° C.). Furthermore, it would be additionally or alternatively also conceivable for the driver to select the “warming up situation” program on his smartphone before he enters the vehicle.

According to one advantageous development of the invention, in the cooling down situation, each of the plurality of air outlets is in the opened state, the flow temperature is low, the flow strength is high and the flow direction of the plurality of outlets is oriented toward seats and/or toward the steering wheel and/or further operating elements of the vehicle.

A typical scenario for the “cooling down situation” program is a vehicle which is located in a car park on a summer's day. In 2018, for example 20 days of external temperatures above 30° C. were measured in Germany, while in this context the internal temperature of the vehicle can rise to over 50° C. within 30 minutes.

With conventional air outlet systems there is the problem here that the individual air outlets are oriented in random outflow directions or are in their closed state so that an efficient exchange of air is not possible. Furthermore, elements of the vehicle which come into contact with the vehicle occupant and therefore are felt to be particularly disruptive when heating up do not automatically have air directed at them by the air outlets.

Since in the “cooling down situation” ventilation program, each of the plurality of air outlets is in the opened state, the flow temperature is low and the flow strength is high, a rapid exchange of the air located in the interior of the vehicle can occur so that rapid cooling down of the vehicle is possible. Furthermore, elements which come into contact with the vehicle occupant, such as for example the seats and/or the steering wheel of the driver, are directly cooled by means of air outlets oriented toward these elements, so that a high level of comfort is produced for the vehicle occupants. Therefore, the flow direction, open state, temperature control and flow strength are optimized in terms of fluidics, in order to ensure “optimum” cooling down.

Furthermore, in the “cooling down situation” program an additional safety function would also be conceivable which is embodied in such a way that it detects the presence of persons and/or animals in the vehicle (for example by means of optical sensors or weight sensors) and then correspondingly initiates safety measures automatically, such as for example the switching on of the ventilation or cooling system, if a critical temperature (e.g. 30° C.) is exceeded. Such a safety function could for example switch on, automatically (immediately) after the closing of the vehicle at a (pre-)determined external temperature (e.g. 20° C. or 25° C.).

According to one advantageous development of the invention, in the ventilating situation, each of the plurality of air outlets is in the opened state, the flow temperature is (preferably) medium, the flow strength is high and the flow direction of the plurality of air outlets is preferably oriented central into the interior of the vehicle, wherein it is preferred that windows and/or a panorama roof are/is at least temporarily opened.

A typical scenario for the “ventilating situation” ventilation program is the exchanging of all of the air in the interior of the vehicle before the vehicle drives off, in order to remove smells which can occur, for example, in new cars when the plastic emits vapors. The “ventilating situation” program can be run here on the standard basis when the vehicle starts or when the vehicle is locked, and can therefore provide a high level of comfort for the vehicle occupants.

Similarly to the situations above, it is possible for the air to be exchanged particularly quickly within the interior of the vehicle since all the air outlets are in the opened state and the flow strength is high. Since the windows and/or the panorama roof are/is opened during the ventilating situation the air can be exchanged more quickly and the vehicle can therefore be ventilated more efficiently. Overall, the flow direction, open state, temperature control and flow strength are optimized fluidically, in order to ensure an “optimum” exchange of air.

According to one advantageous development of the invention, in the solo-traveling situation, of the plurality of air outlets only those that are arranged in the vicinity of the driver are in the opened state, wherein the flow direction of said air outlets in the opened state is oriented toward the driver.

A typical scenario for the “solo-traveling situation” ventilation program is commuting to work. For example, 90% of all commuters travel alone. In conventional air outlet systems, air outlets which are frequently not required during such solo journeys are in the opened state. As a result, the consumption of energy is not optimized but rather there is a considerable waste of energy depending on the setting.

Since in the “solo-traveling situation” program only the air outlets which are arranged in the surroundings (that is to say in the vicinity) of the driver are opened (that is to say in the opened state) and all the other air outlets are closed, there can be a saving in energy by providing a local air conditioning zone around the driver. Furthermore, for example a saving in energy can be achieved by reducing the power of the fan.

A sensor which could detect and specify the solo-traveling situation would be, for example, an optical sensor, such as for example a camera which detects that only the driver is seated in the vehicle, or a weight sensor which detects that a vehicle occupant is seated only on the driver's seat.

Furthermore, it will be possible to broaden the above situation also to a driver and a front seat passenger situation so that in this situation only the rear air outlets, that is to say those oriented toward the rear seats, are correspondingly closed. In such a scenario it is also correspondingly possible to save energy. The regions in the vehicle in which persons are located are then correspondingly air conditioned.

According to one advantageous development of the invention, in the rear seat situation, air outlets in a front region of the vehicle are oriented in the direction of the rear seat and in particular in the direction of the passengers who are sitting on the rear seat.

A typical scenario for the “rear seat situation” program would be traveling with a driver and children or a child on the rear seat, or for example a typical taxi journey with a passenger on the rear seat. With conventional air outlets there is the problem that, for example, children cannot or are not intended to be able to operate the air outlets, and while driving the driver can only have a poor impression of regulation of the air conditioning. Furthermore, in the described scenario the front seat passenger seat is often free so that air outlets which are oriented toward this seat are not used effectively.

Since in the “rear seat situation” program, the air outlets are directed into a front region of the vehicle in the direction of the rear seat and, in particular, in the direction of passengers sifting on the rear seat, it is possible to achieve more effective use of the air outlets. Furthermore, the temperature of the airflow which is directed toward the rear seat can be controlled in such a way that it corresponds to the requirements of the vehicle occupant who is located on the rear seat. It is therefore possible to detect, for example by means of an infrared sensor, the temperature of the vehicle occupant and to adapt the flow temperature in such a way that comfortable air conditioning is achieved for the passenger. This can be advantageous in particular for small children or babies.

According to one advantageous development of the invention, in the telephoning situation, the air outlets that are located near to microphones that are allocated to a hands-free system or are oriented toward said microphones beforehand (before the “telephoning situation” program is run) are in the closed state, operate with a reduced flow strength or are oriented in another flow direction that leads away from the microphones.

Since the air outlets in the vicinity of microphones are oriented away from the microphones, are off (closed state) or operate in a throttled fashion, interference noise at the microphone can be prevented so that improved voice quality is achieved. The “telephoning situation” program can be executed automatically in this context when there are incoming and outgoing calls so that improved voice quality can be achieved here.

Basically, the setting parameters which are associated with the telephoning situation can also be used to ensure that voice commands of a vehicle occupant to the vehicle can be better understood by the vehicle. For this purpose, a corresponding program can be carried out, for example, when it is detected that the driver directs a voice command to the vehicle.

According to one advantageous development of the invention, in the situation for maintaining alertness, in the case of the air outlets in the vicinity of a driver the flow temperature is low, the flow strength is high and the flow direction is oriented toward the driver and preferably toward the face of the driver and/or said flow direction oscillates.

Microsleeping continues to be a frequent reason for traffic accidents, and 26% of all car drivers have already fallen asleep at the wheel.

Since in the “situation for maintaining alertness” of the ventilation program the air outlets direct cold air in the direction of the driver and preferably of the driver's face, the risk of microsleeping can be reduced on the one hand and a driver who has fallen asleep can be woken up on the other hand. In particular, it is not necessary in such a context to provide additional air outlets. Instead, the existing air outlets are oriented in the direction of the driver or of the driver's face.

The specification of the “situation for maintaining alertness” program can be made, for example, by means of an optical sensor which detects the sleepiness or tiredness of a driver and specifies the program correspondingly.

According to one advantageous development in the invention, in the hand warming up/cooling down situation in the case of the air outlets in the vicinity of the steering wheel of the vehicle the flow temperature is high or low, the flow strength is high and the flow direction is oriented toward the steering wheel and preferably toward the hands of the driver, which are preferably arranged on said steering wheel.

The ventilation situation or the “hand warming up/cooling down situation” program can be initiated, for example, by a sensor which detects that the driver's hands are too cold or too warm or moist (sweaty). With conventional air outlets the driver had the problem that a complicated adjustment of the air outlets in the direction of his hands was necessary to be able to reduce freezing or sweating of his hands. In order to achieve a satisfactory result, it was also necessary to use complex systems such as ventilation systems introduced into the steering wheel.

With the “hand warming up/cooling down situation” ventilation program, the driver's hands which are arranged on the steering wheel can easily be cooled or warmed depending on the situation.

According to one advantageous development of the invention, in the fan situation, the plurality of air outlets are preferably oriented synchronously and uniformly in alternating flow directions.

In this context, the air outlets or the flow directions are preferably moved (for example by means of lamellas) in, for example, a vertical direction so that an oscillating airstream is provided within the interior of the vehicle. In other words, the flow direction of the air outlets changes in a fluid fashion from left to right and back again (or from top to bottom and back again), so that a “fan movement” is produced. This increases the comfort in the interior of the vehicle and correspondingly provides the vehicle occupants with a refreshing sensation.

### BRIEF DESCRIPTION OF THE DRAWINGS

The invention will be explained in more detail below by means of the description of exemplary embodiments and with reference to the appended drawings, in which:

FIG. 1 shows a schematic view of the position of the air outlets in the “warming up situation” ventilation situation;

FIG. 2 shows a schematic view of the position of the air outlets in the “solo-traveling situation” ventilation situation;

FIG. 3 shows a schematic view of the position of the air outlets in the “rear seat situation” ventilation situation;

FIG. 4 shows a schematic view of the position of the air outlets in the “situation for maintaining alertness” ventilation situation; and

FIG. 5 shows a schematic view of the position of the air outlets in the “hand warming up/cooling down situation” ventilation situation.

### DETAILED DESCRIPTION

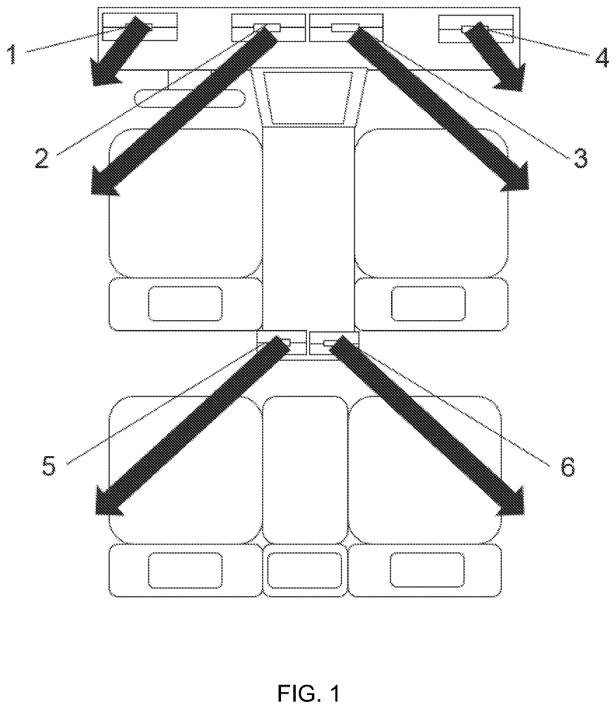

FIG. 1 shows a schematic view of the position of air outlets (1, 2, 3, 4, 5 and 6) in the “warming up situation” ventilation situation. Here, the vehicle has, for example, 6 air outlets (1, 2, 3, 4, 5 and 6), wherein the air outlets 1 and 2 lie in the vicinity of a driver, the air outlets 3 and 4 in the vicinity of a front seat passenger, and the air outlets 5 and 6 in the vicinity of rear seat passengers. In this context, each of the air outlets is in the opened state and air flows at a high flow temperature and with a high flow strength into the interior of the vehicle. In particular, the air outlets 1, 2, 3, 4, 5 and 6 can be oriented toward the windows of the vehicle, so that they can be quickly defrosted.

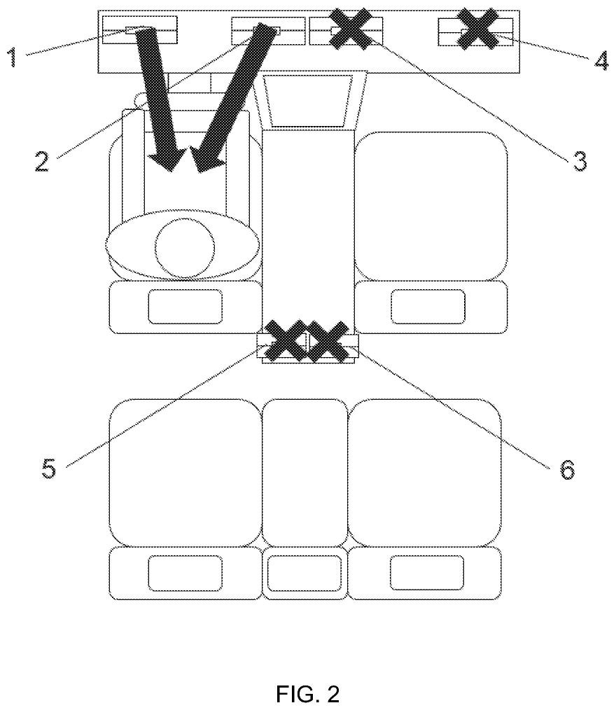

FIG. 2 shows the “solo-traveling situation” ventilation situation, wherein the air outlets 1 and 2, which are arranged in the vicinity of the driver, are in the opened state, and all the other air outlets 3, 4, 5 and 6 are in the closed state. Furthermore, the flow directions of the air outlets 1 and 2 are oriented or directed toward the driver. Since the air outlets 3, 4, 5 and 6 are closed, a saving in energy can be achieved. In particular, a local air conditioning zone is produced around the driver here.

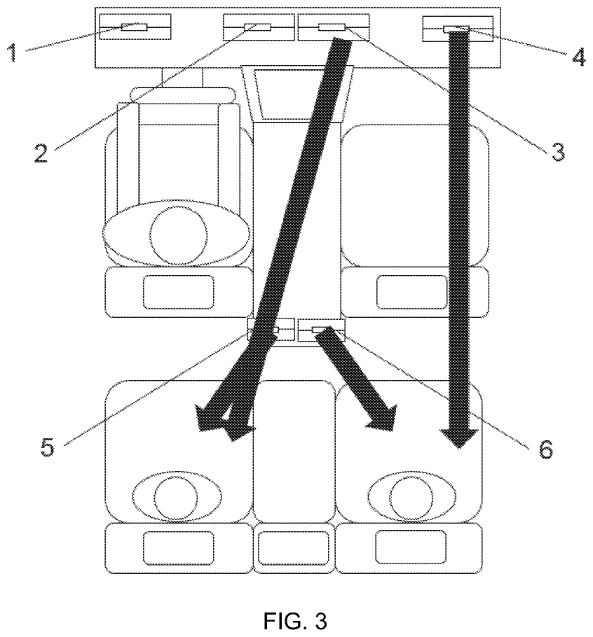

FIG. 3 shows the “rear seat situation” ventilation situation in which a driver is sitting in the vehicle and two children are sitting on the rear seat. In particular, it is apparent here that the air outlets 3, 4, 5 and 6 which are not required by the driver are oriented toward the children who are located on the rear seat, so that pleasant air conditioning can be provided for the children as quickly as possible. If, for example, just one vehicle occupant was seated on the rear seat here, all the air outlets 3, 4, 5 and 6 can be correspondingly oriented toward said occupant.

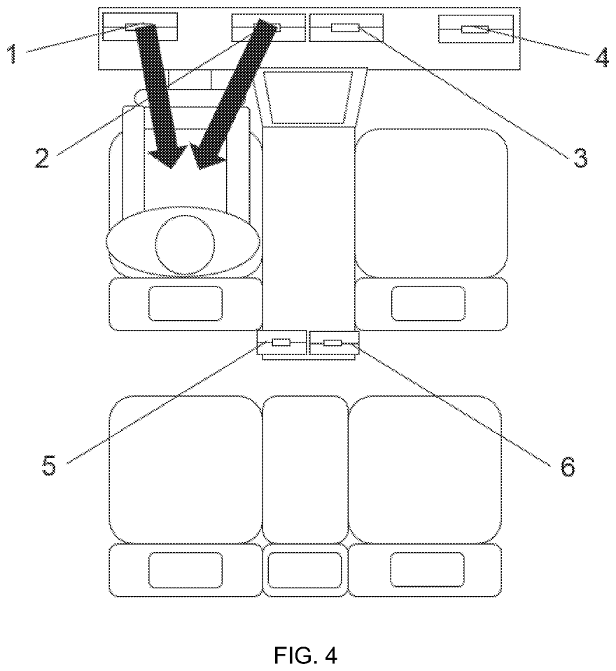

FIG. 4 shows the “situation for maintaining alertness” ventilation situation in which the air outlets 3, 4, 5 and 6 are not required, but rather only the air outlets 1 and 2 are, said air outlets being oriented with their flow direction in the direction of the driver. As a result it is possible to target a flow of cold air on the driver so that the risk of microsleeping is reduced or microsleeping can even be prevented.

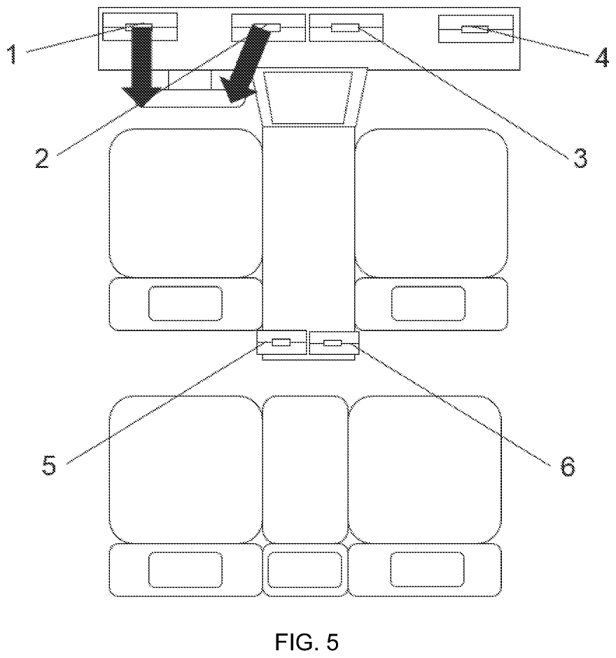

FIG. 5 shows the “hands warming up/cooling down situation” ventilation situation in which the air outlets 1 and 2 are oriented toward the steering wheel or the driver's hands. The air outlets 3, 4, 5 and 6 are not required in this situation. As a result it is possible to orient warm or cold air toward the driver's hands, in order to provide said driver with a higher level of driving comfort.

1. An automatic air outlet system for supplying air into a vehicle interior of a vehicle, wherein the automatic air outlet system comprises the following:
a plurality of air outlets that are motorized and may be automatically adjusted and that respectively comprise a plurality of setting parameters;
a storage unit for storing a plurality of ventilation situations, wherein in the case of each of the plurality of ventilation situations a specific configuration of the setting parameters of each air outlet of the plurality of air outlets is specified, said configuration being adjusted to the corresponding ventilation situation;
a specification unit that is embodied for the purpose of specifying a ventilation situation to the plurality of ventilation situations that are stored in the storage unit; and
a control unit that is embodied for the purpose of controlling the plurality of air outlets in such a manner that said air outlets fulfil the ventilation situation that is specified by the specification unit.

2. The automatic air outlet system as claimed in claim 1,
wherein the specification unit comprises at least one sensor, wherein based upon a measured variable of the sensor the specification unit automatically specifies at least some of the ventilation situations that are stored in the storage device.

3. The automatic air outlet system as claimed in claim 2,
wherein the at least one sensor is an optical sensor, a weight sensor, a temperature sensor, an infrared sensor, a moisture sensor or a contact sensor.

4. The automatic air outlet system as claimed in claim 1,
wherein the specification unit receives an operating element input, a touchscreen input, a voice input and/or an input by means of a smartphone or key for specifying at least some of the ventilation situations that are stored in the storage unit.

5. The automatic air outlet system as claimed in claim 1,
wherein the setting parameters of the plurality of air outlets comprise at least two of the following parameters: opened/closed state; flow temperature; flow strength, flow direction.

6. The automatic air outlet system as claimed in claim 1,
wherein at least two of the following ventilation situations are included in the plurality of the ventilation situations that are stored in the storage unit: a warming up situation having optimized setting parameters for rapidly warming up the vehicle interior prior to starting a journey; a cooling down situation having optimized setting parameters for rapidly cooling down the vehicle interior prior to starting a journey; a ventilating situation having optimized setting parameters for rapidly exchanging the air in the vehicle interior; a solo-traveling situation having optimized setting parameters for solo-traveling; a rear seat situation having optimized setting parameters when passengers are on the rear seat; a telephoning situation having optimized setting parameters when telephoning on a hands-free device; a situation for maintaining alertness having optimized setting parameters for maintaining the alertness of a driver and/or waking up a driver; a hand warming up/cooling down situation for warming up and/or cooling down the hands of a driver; a personalization situation having personalized, preset parameters of occupants; and a fan situation having optimized setting parameters for oscillating air in the vehicle interior.

7. The automatic air outlet system as claimed in claim 6,
wherein in the warming up situation, each of the plurality of air outlets is in the opened state, the flow temperature is high, the flow strength is high and the flow direction of the plurality of air outlets is oriented toward seats, toward windows, toward the roof and/or toward the steering wheel and/or further operating elements of the vehicle.

8. The automatic air outlet system as claimed in claim 6,
wherein in the cooling down situation, each of the plurality of air outlets is in the opened state, the flow temperature is low, the flow strength is high and the flow direction of the plurality of air outlets is oriented toward seats and/or toward the steering wheel and/or further operating elements of the vehicle.

9. The automatic air outlet system as claimed in claim 6,
wherein in the ventilating situation, each of the plurality of air outlets is in the opened state, the flow strength is high and the flow direction of the plurality of air outlets is oriented centrally into the interior of the vehicle, wherein windows and/or a panorama roof are at least temporarily opened.

10. The automatic air outlet system as claimed in claim 6,
wherein in the solo-traveling situation, of the plurality of air outlets only those that are arranged in the vicinity of the driver are in the opened state, wherein the flow direction of said air outlets in the opened state is oriented toward the driver.

11. The automatic air outlet system as claimed in claim 6,
wherein in the rear seat situation, air outlets in a front region of the vehicle are oriented in the direction of the rear seat and in particular in the direction of the passengers who are sitting on the rear seat.

12. The automatic air outlet system as claimed in claim 6,
wherein in the telephoning situation, the air outlets that are located near to microphones that are allocated to a hands-free system or are oriented toward said microphones beforehand are in the closed state, operate with a reduced flow strength or are oriented in another flow direction that leads away from the microphones.

13. The automatic air outlet system as claimed in claim 6,
wherein in the situation for maintaining alertness, in the case of the air outlets in the vicinity of a driver the flow temperature is low, the flow strength is high and the flow direction is oriented toward the driver and/or said flow direction oscillates.

14. The automatic air outlet system as claimed in claim 6,
wherein in the hand warming up/cooling down situation in the case of the air outlets in the vicinity of the steering wheel of the vehicle the flow temperature is high or low, the flow strength is high and the flow direction is oriented toward the steering wheel.

15. The automatic air outlet system as claimed in claim 6,
wherein in the fan situation, the plurality of air outlets are oriented synchronously and uniformly in alternating flow directions.
